(19) United States
(12) Patent Application Publication
(10) Pub. No.: US 2007/0130026 A1
(43) Pub. Date: Jun. 7, 2007

(54) Method and system for providing business listings utilizing time based weightings

(75) Inventors: Bruce L. O'Pray, Ridgewood, NJ (US); Steven Klein, Wayne, NJ (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: CONTROL RESOURCES LLC, Rochelle Park, NJ (US)

(21) Appl. No.: 11/437,078

(22) Filed: May 19, 2006

Related U.S. Application Data
(60) Provisional application No. 60/742,932, filed on Dec. 6, 2005.

(51) Int. Cl. G06F 17/30

(52) U.S. Cl. 705/27; 705/26

(57) ABSTRACT

In order to provide enhanced database-derived information, such as enhanced directory assistance, a directory assistance operator receives a request from a telecommunications system user for listing information of a business that provides a desired product or service. A merchant database, containing business listings, as well as detailed data regarding products and services sold by at least some businesses, is searched in accordance with rules that consider travel time to the merchants and other known characteristics relating to the desired product or service. The search results are then presented to the user through spoken and/or visual means.

### CROSS-REFERENCE TO RELATED APPLICATION

The present application claims the benefit of co-pending U.S. Patent Application, Ser. No. 60/742,932, filed Dec. 6, 2005, by Bruce O'Pray et al, entitled: “Method and System for Providing Business Listings Utilizing Time Based Weightings,” assigned to the assignee of the present application, and the disclosure of which is incorporated herein.

### FIELD OF THE INVENTION

The present invention relates in general to the field of information storage and retrieval services and systems therefor, and particularly to a methodology for obtaining information about local providers of goods/services by searching through databases of information storage and retrieval systems, such as directory assistance systems, in accordance with rules that take into account travel time to a goods/services provider and other known characteristics relating to the sought product or service. The search results are then supplied to the user by audio and/or visual output.

### BACKGROUND OF THE INVENTION

Directory assistance is an example of an information storage and retrieval system that is commonly available from wired, wireless and Internet communication service providers as a service that may be purchased by people using their network. One such known directory assistance system is diagrammatically illustrated in the block diagram of FIG. 1. Generally, a user, or caller, 100 places a call through a telephone network 110 in order to access a directory assistance platform 120. The directory assistance platform 120 then connects the caller to a directory assistance operator 130 and/or a voice server 140, in order that the particular information the caller is seeking can be determined. Typically, the caller provides the name of a business or person and the city in which that business or person is located. A lookup is then initiated through the directory assistance platform 120 to an alphabetical listings 150 database, in order to retrieve the corresponding phone number or address. The directory assistance operator 130, or voice server 140, then provides to the caller 100 the requested phone number or, if there are multiple listings, interacts with the caller to select the particular party that the he or she has in mind.

With some directory assistance services, such as 411 offerings of major wireless service providers, it is possible to request listings for businesses or providers of goods/services (or merchants) that the directory assistance customer does not know by name. In these cases, the customer can be offered a business such as a “plumber” or “auto dealer”, that has been categorized by the “type” of goods and services it offers. These “category search” services lack the facilities to select merchants within a category based upon specific requirements. For example, a request for a “plumber” is supported, but a request for “a plumber that provides emergency service” is not. Generally, a category search caller 100 requests the location or phone number for a certain type of business and the operator 130 or voice server 140 obtains a corresponding listing from a categorized merchant listings database 170 that has been created and periodically updated through a categorized business listings file 160. Since category search services lack specific information, such as the actual products and services offered by individual merchants, they typically provide business listings within a given city and category based on random selection, thereby eliminating a basis for complaints that the directory assistance service provider is unfairly favoring one merchant over another. In addition to random methods, some category search services can find a merchant that is geographically closest to a user provided location.

While directory assistance category search services can be useful in some cases, this usefulness is limited, because it is only possible to search by type of business and not at a product or service level. Often, a person wants to find a business based upon the availability of particular products, performance of specific services, certain business hours, or specific payment methods. For example, a caller seeking “a locksmith that unlocks car doors and takes Visa” is better served if the resulting listing is based upon detailed information about locksmiths in the desired area. Otherwise, the caller may have to contact multiple locksmiths before he or she finds one that offers the desired services.

One problem in selecting merchants in the desired manner is that detailed product or service data is not generally available for most businesses. Less than half of all businesses advertise in the most widely used directional local business media—the yellow pages telephone directories. Furthermore, yellow pages advertisements generally describe only a small percentage of the products and services that are available through the associated advertisers. A major problem that must be solved, in order to provide improved category search, is establishing a practical means of obtaining sufficient information about products and services offered by at least the minimum number of individual businesses necessary to provide useful search results.

Even if detailed product and service information about businesses in the categorized listings database were available, selection of a merchant only based on matching specified product or service criteria would be an incomplete solution. The reason for this is that selecting a merchant to meet a specific “need” is a very complex process, involving tradeoffs between the time required to travel to a merchant and whether the desired products or services are: advertised by that merchant, commonly sold by most merchants in the selected category, major purchases, or minor purchases. Offering to the caller a merchant that is specifically known to offer a certain product or service, but whose location is a significant travel time away from the caller, may not be a good answer, if there is a merchant having a location that would take much less time to travel to, and could meet that need, even though detailed data indicating that the merchant meets the need is not explicitly available. For example, very few pharmacies advertise that they sell “aspirin”, but almost any pharmacy sells it, so that offering a pharmacy in response to a request for aspirin that does not advertise aspirin but is only five minutes travel time away from a caller's location, is a more useful answer than a pharmacy that advertises aspirin but is fifteen minutes away. Conversely, were a caller to seek a pharmacy that was open twenty-four hours per day, then only pharmacies that advertised those hours of operation should be presented to the caller, because most pharmacies are not open twenty-four hours per day.

Additionally, many people believe that establishments with a substantial advertising presence have greater selections and more attractive pricing than smaller merchants. For this reason, relative advertising expenditures can be considered in merchant selection as well. For example, a search for a source of diamond rings should recognize that a jeweler located fifteen minutes from the caller's location and having a large print yellow pages ad can be as good an option as a jeweler with a small ad that is just around the corner. Conversely, the nearby jeweler is a better option for a caller seeking to have his or her watch battery replaced, because price differences and broader selection are not significant factors in this type of purchase, and additional travel time is unwarranted.

n addition to category search services purchased by callers, the issues raised above also apply to an emerging class of directory assistance services that are paid for by advertisers. The business model for these emerging services is based upon providing listings for merchants that have agreed to compensate the directory assistance provider for higher placement in directory assistance need based lookups through paid advertising fees. In order for callers to be satisfied with directory assistance service and thereby repeatedly use it, they must find the listings they receive to be useful. Furthermore, it is only possible to present a small number of listings via speech, or to the small mini-screen of a mobile telephone. Therefore, only advertisers that are ‘likely’ to be considered should be presented to a caller. For example, as described above, individuals are typically willing to travel for a significant amount of time to make an expensive purchase, such as a car, so that inclusion of an auto dealership advertiser that could take one-half hour to reach can be justified. Were the caller to request a business that could provide an inexpensive service, such as an oil change, then inclusion of this same auto dealer, in place of a non-advertiser business having a location only ten minutes from the caller, would dissatisfy the user, with little benefit to the advertiser. The user is dissatisfied because one of a small number of options presented to him is unsuitable. The advertiser receives little benefit, because few users are likely to travel for one-half hour for an oil change, if a suitable alternative is only ten minutes away.

As can be seen from the above examples, merchant selection methodology is complex and dependant upon the particular products or services that are being sought. Additionally, it is impractical to train human operators about the thousands of products and services that are available through hundreds or even thousands of different types of businesses, so that they can make these tradeoffs. Furthermore, interaction between a caller and an operator to discuss these issues would be very time consuming. Since directory assistance is relatively inexpensive, this increased operator time would significantly impact the profitability of the directory assistance provider.

Examples of prior art documentation that describes merchant searching, and utilizes detailed information relating to products and services, includes U.S. Pat. Nos. 6,466,910 and 6,189,003. The search methodology described in U.S. Pat. No. 6,466,910 utilizes text-to-speech conversion, for speech-based delivery to a caller of detailed information regarding a selected merchant, enabling the caller to then determine whether that merchant is likely to meet his or her needs. While potentially useful in choosing one merchant over another, using this approach to select one merchant from the lengthy list available through a category search is impractical, since the user would have to listen to information for many merchants and then determine which one to call. The search scheme described in U.S. Pat. No. 6,189,003 offers a method of narrowing a long list of merchants to only those that exactly match product or service criteria. However, this method fails to address the complex issues associated with selecting a merchant, including travel time, and whether the item being sought is commonly available through most businesses in the selected category.

Examples of methods for selecting merchants that provide particular products or services based on the use of keywords in a defined locale are described in U.S. patent application Publications: 2003/0223565; 2003/0225682; 2004/0006511; 2004/0023644; and 2004/0010518. One significant shortcoming of these approaches is that that the differences in the time required to travel to different merchants in the same locale are not considered. A second shortcoming is that there is no means for considering merchants that may provide a desired product or service, and do not advertise it, eliminating alternatives that may be more convenient for the caller to visit.

A method for selecting merchants based on proximity is described in U.S. patent application Publication 2005/0015307. One significant shortcoming of this approach is that it fails to consider travel time to a merchant, but rather relies upon the use of distance to alternative merchants, as a component of the search criteria. Since the travel time for a given distance can vary substantially between urban and rural areas, this leads to inaccurate search results.

In summary, conventional information storage and retrieval systems for supplying information about providers of goods and/or services, such as directory assistance systems, suffer from numerous disadvantages, because comprehensive detailed information regarding products and services offered by large numbers of businesses is not available, and existing lookup facilities fail to consider the multiplicity of factors involved in selecting merchants that are both geographically nearby and likely to meet a caller's need. These factors include the particular product or service that is desired, travel time from the caller location to potentially suitable merchant locations, individual merchant advertising presence, likelihood that the desired product or service is generally available, likely differences in pricing and selection between merchants, and that different types of businesses are suited to different search strategies.

Individuals seeking merchants to provide them with products or services would find it very helpful, if they could obtain listings for nearby businesses that meet their specific product or service needs. This information-providing functionality would be especially helpful for mobile users that do not have ready access to yellow pages telephone directories or the Internet. Additionally, communication service providers are very interested in increasing their revenues through additional call volume resulting from a service that provides more useful listings than the current category search.

Providers of advertiser supported services such as directory assistance wish to deliver a superior user experience by consistently providing the most suitable merchant choices, selected from both advertisers and businesses that do not advertise. This superior experience would generate substantial repeat usage, leading to growth in advertising revenue from existing advertisers, as well as new advertisers that are attracted by the success of the service.

In view of the foregoing, it can be appreciated that a substantial need exists for a telecommunications based method and apparatus that makes enhanced delivery of goods/services provider information available, and solves the problems discussed above.

### SUMMARY OF THE INVENTION

The present invention addresses shortcomings of prior art described above, and allows users of goods/services information storage and retrieval systems, such as, but not limited to, directory assistance systems and web applications accessed through mobile telephones, to obtain information about local organizations that are likely providers of the products and services they are seeking. While the primary application of the present invention is to identify local business establishments that a customer may wish to visit or that may dispatch their personnel to locations associated with a customer, it can also be used to identify non-business entities that a user may wish to find, such as government offices or schools. For this reason it should be understood that the terms “business” or “merchant” represent any type of enterprise which provides products or services in a particular locale.

The present invention encompasses both methodologies used for the creation of a local merchant database that contains information about providers of products and services and methodologies used to search such a database once it has been created. Local merchants are businesses that serve a particular locale through physical presence. This includes professional offices and retail stores visited by purchasers of goods and services, as well as businesses that provide their product or service at a customer location designated by the customer, such as a home or office.

The merchant database contains information necessary to contact local merchants within a geographic area, if there are different types of businesses within the merchant database, the category that represents the type of business that individual merchants are in. The local merchant database may also contain information that pertains to the business as a whole, such as advertising presence, or consumer ratings. The merchant database also includes detailed information regarding products and/or services offered by at least some of these merchants. This information regarding products and services is represented by database attributes that can be useful in choosing one merchant within a given type of business over another. A non-limiting example of a category is “restaurants” and a non-limiting example of an attribute within the restaurant category is “outdoor dining”. Merchant attribute data may be obtained from multiple sources and can be based on a wide range of merchant characteristics such as products, services, brands, makes, hours of operation, and payment methods. Furthermore, a large amount of this local merchant data is only available in the form of non-uniform descriptive terminology in advertisements, web sites and other media. In order to insure that all nearby merchants that offer a product or service that meets a user's needs are considered, different terms that describe the same product or service must be “normalized” so that they are associated with the same attribute. Additionally, attributes that designate products or services that are commonly sold by the same merchant are associated through grouping in order to create a second tier of search alternatives. Finally, information is extracted from merchant names as a means of assigning attributes to particular merchants and also identifying merchants that specialize in only providing a particular product or service.

An example of this in the furniture category is for merchants advertising “couch” and “sofa” to be associated with the “sofa” attribute, and merchants with the sofa attribute to also have the “living room furniture” group designation. In addition, merchants with “sofa” or “couch” in their names would be assigned the “sofa” attribute and also be identified as specialists, providing a means of preventing their inclusion in search results for other types of furniture such as “dining tables”.

Selection of a suitable merchant from the database includes considering travel to the alternative merchant locations, whether the merchant has advertised the desired product or service, and the general desirability of the merchant. This is accomplished through a travel time based weighting system. Individual merchants can have entity time values based upon general characteristics, including but not limited to ad size or ratings. For example, a merchant with a full page ad may be assigned a value of ten minutes meaning that such a merchant is equivalent to a merchant with identical qualifications and no ad that is ten minutes of travel closer to a user provided location. In like fashion, groups and individual attributes can also have travel time values based upon many factors such as the purchase value of that type of product or service or whether most merchants in a selected category commonly offer the associated products or services represented by a group. For example, for furniture businesses, the sofa attribute could have a travel time value of fifteen minutes, meaning that it is worth traveling up to fifteen minutes longer to visit a furniture merchant with this attribute than it is for identically qualified furniture merchants lacking the sofa attribute and living room furniture group designation. In similar fashion, merchants without the sofa attribute but with the living room furniture group designation could be assigned a travel time value of five minutes more desirable than identically qualified merchants without the living room furniture group designation and ten minutes less desirable than merchants with the sofa attribute.

The merchant search methodology of the present invention considers the business category that a caller is seeking, the location that the caller would like the business to be near, the travel time for the user to reach alternative businesses of the selected type, travel time-based merchant weightings, and the exclusion of non-matching specialist merchants in search results.

Factors associated with the business category that a caller is seeking include determination of applicable search methodology and the maximum time based range for inclusion of merchants to be considered. The present invention supports different search methodologies based on whether the selected category is one in which customers typically visit a merchant location or individuals associated with the business typically visit the customer's location. Most retail establishments are classified in the “visit” category, since the customer typically travels to the merchant location, and travel time by customers to retail locations can be consistently applied because both endpoints are known and do not change. Many service establishments are classified as “non-visit”, because representatives of the business perform services at the customer location. In these cases, consistent determination of travel time is impractical, because non-visit merchants may not normally travel from their base of operations to customer locations, but rather from the previous customer location to the next one.

The maximum time based range facilitates more comprehensive search results by allowing the inclusion of merchants outside the city identified as part of the search criteria. This can be effected through use of a category time entry which corresponds to the travel time to the most distant merchant to be included in a search of the subject category. This travel time parameter is converted to distance based upon the travel speed of a given locale to establish the geographical area to be considered for any given merchant search.

The user location is necessary, in order to determine travel times between the user and various merchant alternatives. Travel time can be calculated in a variety of ways, with the simplest based upon both distance and a travel speed associated with individual merchant locations.

Travel time-based merchant weight values are applied in accordance with predetermined business rules associated with the type of business that the user is seeking. Generally, a travel time weight is first calculated for a merchant based upon any weights associated with the merchant as an entity and the weights of attributes or groups that are part of the search criteria. For visit business types, the travel time between the merchant and the user provided location is then subtracted from this total weight. The resulting score is then used to rank merchants in descending order. A similar methodology is used to determine merchant travel time weight with different travel time based adjustments that reflect the previously described uncertainties associated with non-visit merchant travel.

In summary, the information storage and retrieval system of the present invention provides a mechanism for assembling detailed information regarding products, services, and capabilities of individual merchants. It provides a mechanism for valuing this information through a common travel time based system. It provides a mechanism for selecting merchants through search strategies selected by business type that consider travel time based merchant weights and travel time between the user and alternative merchants. It is suited to applications provided through a wide range of media, including wired, wireless, and Internet services. It can be used with most user interfaces, including human operators, speech recognition, visual, and multi-modal technology.

### BRIEF DESCRIPTION OF THE DRAWINGS

FIG. 1 is a block diagram of a known directory assistance system;

FIGS. 2A and 2B are block diagrams of a directory assistance system according to an embodiment of the present invention;

FIGS. 3A-3D illustrate details regarding the periodic creation of a local merchant database system according to an embodiment of the present invention;

FIG. 4 is a flow chart that illustrates the steps of a directory assistance call according to an embodiment of the present invention; and

FIGS. 5A and 5B taken together, depict a flow chart that illustrates the steps for performing a merchant search according to an embodiment of the present invention.

### DETAILED DESCRIPTION

Before describing in detail the improved time-based, goods/services provider information storage and retrieval system, and database search methodology therefore in accordance with the present invention, it should be observed that the invention resides primarily in what is effectively a method of using conventional storage and retrieval and telecommunication hardware components and attendant supervisory communications circuitry therefor, that controls the operations of such components. Consequently, the configuration of such components and the manner in which they are interfaced with other storage and retrieval and communication equipment have, for the most part, been illustrated in the drawings by readily understandable block diagrams and associated flow charts, which show only those specific details that are pertinent to the present invention, so as not to obscure the disclosure with details which will be readily apparent to those skilled in the art having the benefit of the description herein. Thus, the block diagram and flow chart illustrations of the Figures are primarily intended to show the major components of the system in a convenient functional grouping, whereby the present invention may be more readily understood.

As described briefly above, the present invention improves upon shortcomings of the prior art, so as to enable telecommunications users to obtain information about businesses that are likely providers of the products and services they are seeking. Consumers will find this very helpful, especially in mobile and hands-free environments, where other print or electronic alternatives are unavailable or impractical. The enhanced data and search capabilities of the preferred embodiment of the invention provide highly relevant answers to a wide range of user needs, such as “a locksmith that unlocks car doors and takes Visa” or “a restaurant that serves breakfast”.

While the primary application of the present invention is to identify local business establishments that a customer may wish to visit or that may dispatch their personnel to locations associated with a customer, it can also be used to identify non-business entities that a user may wish to find, such as government offices or schools. For this reason it should be understood that the terms “business” or “merchant” represent any type of enterprise which provides products or services in a particular locale.

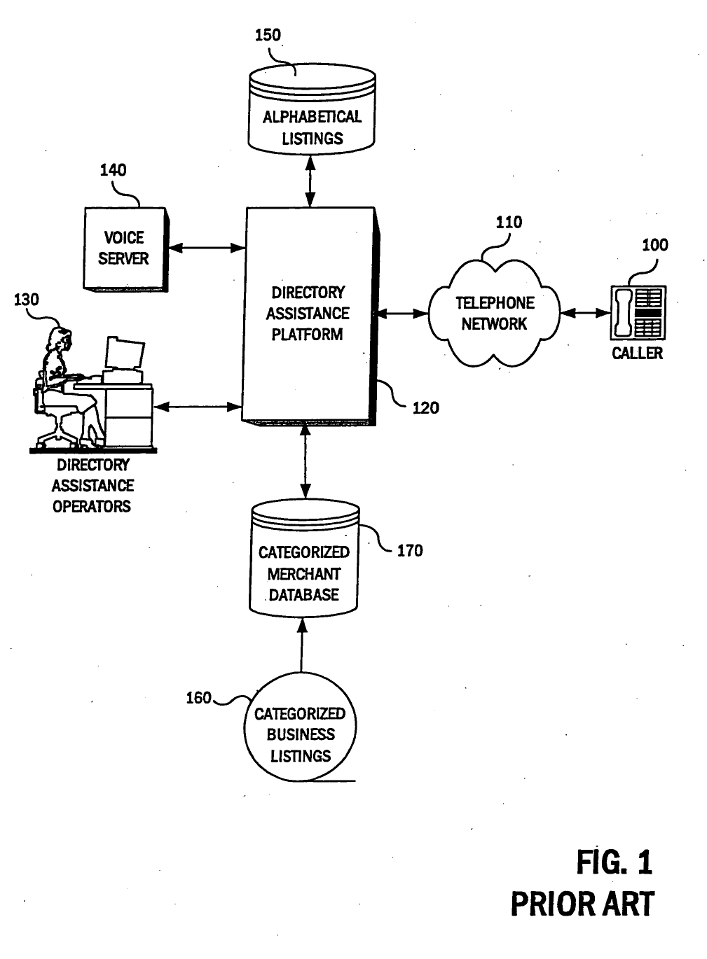

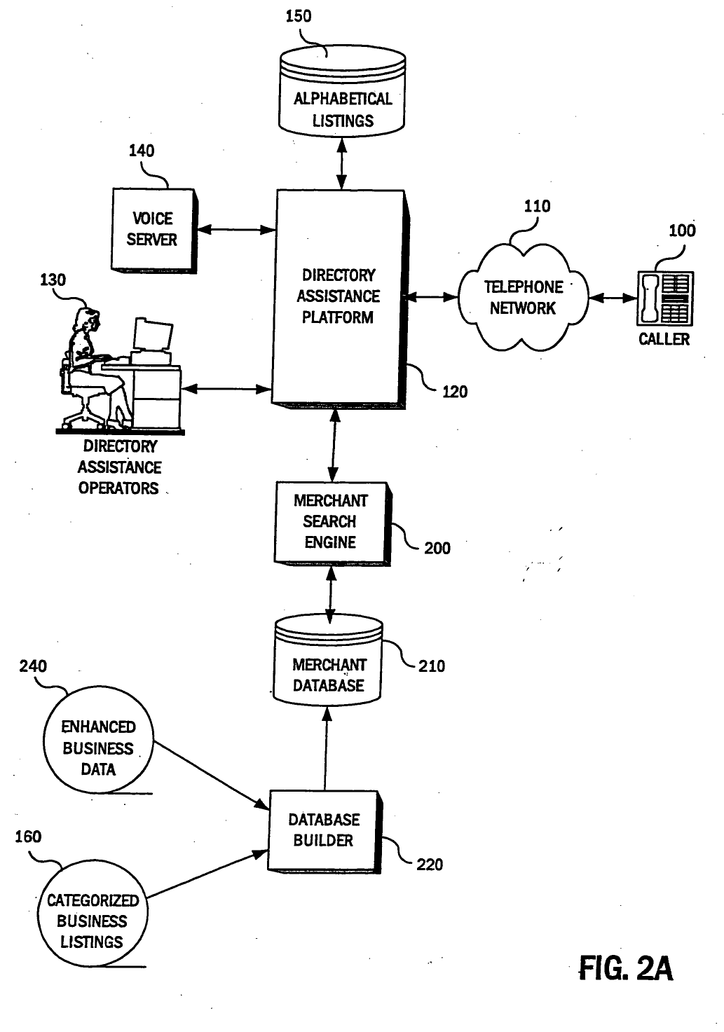

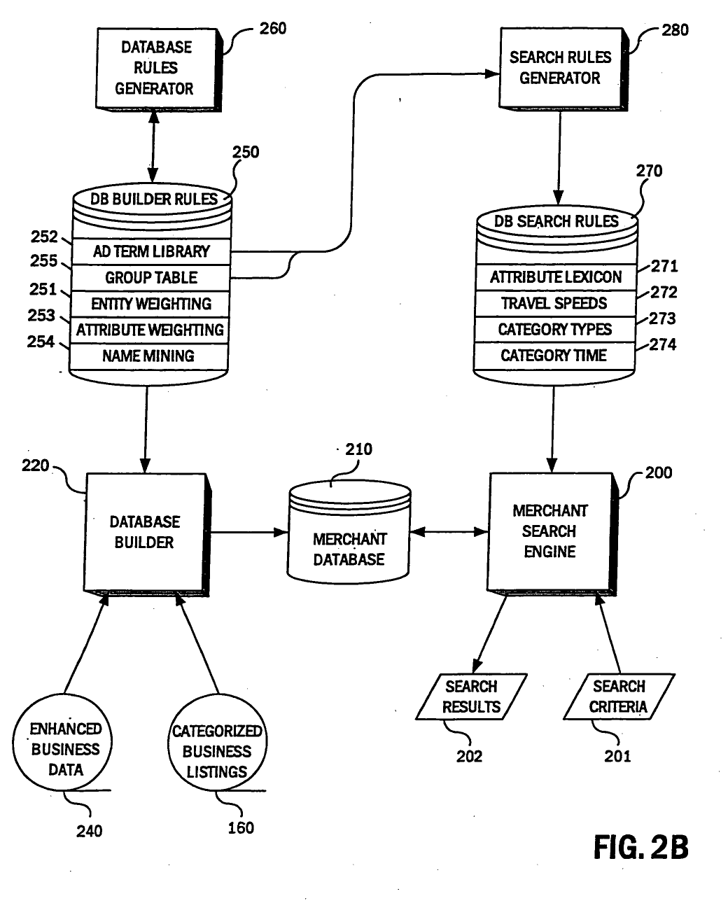

Attention is initially directed to the block diagram of FIG. 2A, which diagrammatically illustrates the interrelationship of the major components of a preferred embodiment of the present invention. As in a conventional directory assistance system of the type shown in FIG. 1, described above, a caller 100 may access a directory assistance system, through a telephone network 110, to a directory assistance platform 120. The call may be answered by an operator 130, or voice server 140. The operator and/or the voice server collect information from the caller that characterizes their requirement. The category search methodology of the system of FIG. 1 is improved through the addition of a goods/services provider information storage and retrieval system that consists of a merchant search engine 200, which queries a merchant database 210 that is constructed by a database builder 220, from categorized business listings 160 and enhanced business data 240.

Enhanced business data 240 contains information about individual businesses that is useful in choosing one merchant over another. Information that may apply to a business as an entity includes whether they have an advertising relationship with the provider of the information storage and retrieval system (e.g., directory assistance) service, the level of their advertising presence through other media, and/or a third party rating. Enhanced business data may include a wide range of additional information such as products, services, brands, makes, hours of operation, and payment methods hereinafter referred to as “products and services”. This information may be obtained from paid advertising subscribers as part of a registration process, as well as from broad based sources, such as yellow pages telephone directory advertisements, information extracted from yellow pages headings, company web sites, business information services, and credit bureaus. Enhanced business data may be obtained in many other ways, including, but not limited to, contacting merchants directly, from industry specific sources such as restaurant guides, travel guides, physician or attorney references, information from manufacturers or distributors indicating business locations that sell their products, and information from government agencies listing businesses that offer particular services.

The database builder 220 processes the enhanced business data 240 and categorized business listings 160 to create consolidated business information for a large number of businesses in the form of a merchant database 210 that supports searching by business category, as well as products and services within boundaries described by city, county, zip code(s), latitude and longitude, or geographic radius.

The merchant search engine 200 accepts search criteria collected by the directory assistance operators 130 or voice server 140. This search criteria includes: a “search locale” that identifies the locus of the search, the business category, specific products or services that the user is seeking, and a “user location” from which the user will travel to the merchant. The merchant search engine 200 performs database searches, in accordance with methods that are defined for both category and the selected search locale. One or more business listings that most closely match the user requirement are then returned to the directory assistance platform for delivery to the caller.

FIG. 2B provides a more detailed illustration of subsystem components that are used to periodically build the merchant database 210. These components include a database rules generator 260, consisting of software programs used to create business rules, in the form of software and parameters, that are stored in a database ‘builder’ rules repository 250. Business rules are defined for each business category, because the associated products and services vary by type of business. For example, the business rules used to find a florist that sells roses are different from the business rules used to find a plumber that can fix a leaky faucet.

The database builder rules of the repository 250 are applied by database builder 220 to process and combine information from the categorized business listings and the enhanced business data into a single merchant database, so that business information from multiple sources is integrated into a common searchable form. The database rules within the database rules repository 250 include an entity weighting 251, which provides a means of assigning time values to individual merchants as entities. These time values may be based upon many different forms of information, such as, but not limited to, merchant rating information, paid advertising fees, advertising expenditures with third parties, and advertisement sizes. For example, a florist A that has a large yellow-pages ad could be assigned a weighting of five minutes, a florist B that has a small yellow-pages ad could be assigned a weighting of three minutes, and a florist C that has no ad could have a weighting of zero minutes. For these examples, florist A will be offered to the user ahead of florist B, as long the user does not have to travel for more than two additional minutes to get to florist A, than would be required for the user to travel to florist B. Similarly, florist B will be offered to the user ahead of florist C, as long as the user does not have to travel for more than three minutes longer to get to florist B, than would be required for the user to travel to florist C. The time value for each element that can provide an entity weight may be obtained from a table created by human editors. Alternatively, different techniques may be employed to establish these weightings, such as consumer surveys and analysis of user choices in an operating directory assistance system.

The database rules within the database builder rules repository 250 further includes an ad term library 252, which is used to assign terms with similar meanings from advertisements or other sources of enhanced business data to a common searchable database attribute. For example, in a furniture category, “wide selection of couches”, “sofas in all sizes”, and “1001 love seats” are all ad terms associated with the database attribute “sofa”. The ad term library 252 can be built by human editors, who create individual category taxonomies, and then assign terms from various sources to the resulting attributes. Other means, such as computer-based linguistics, may alternatively be employed to accomplish this task.

The database builder rules repository 250 further includes an attribute weighting operator 253, which is a method by which a value is assigned to each attribute that indicates the amount of additional time a caller can be expected to travel because a merchant has advertised, or is otherwise known to offer, the product or service the caller is seeking. Criteria that may be considered in arriving at this value include ratings, the price range of the particular attribute, its general availability from all merchants in a category, and paid advertising fees associated with a specific attribute.

Thus, in the above example, florists A and B could both have a “rose attribute” with associated attribute weightings of two minutes, while florist C does not have a rose attribute. In this case, florist A will be offered to the user ahead of florist B, as long as the user would not have to travel for more than four additional minutes (two minutes difference in entity weight plus two minutes for attribute weight) to reach florist A than would be required for the user to travel to florist B. Similarly, florist B will be offered to the user ahead of florist C, as long as the user would not have to travel for more than five minutes (three minutes difference in entity weight plus two minutes for attribute weight) longer to reach florist B, than would be required for the user to travel to florist A. Attribute weighting is preferably implemented in the form of a table for each category, with rows consisting of attribute IDS, one or more columns for each source of the previously described attribute information, and time values in the individual table locations. Alternatively, a variety of other lookup or computational methods may be used to convert attribute characteristics to time values. Attribute weighting can be defined in many different ways, such as assignment by a human editor, as a result of consumer surveys, and analysis of user choices in an operating directory assistance system.

Note that it is possible to establish weighting as a series of distances based on the travel speed of particular types of locales. For example, a particular database element could have a distance based weighting of one mile for locales with a travel speed of ten miles per hour and three miles for locales with a travel speed of thirty miles per hour. In both cases the distance weight would convert to a travel time weight of six minutes. The assignment of distance based weighting to database elements may be employed as an alternative scheme where different distances are assigned to the same database element based on the characteristics of individual locales.

The database builder rules repository 250 additionally includes a name-mining operator 254, which facilitates the application of business rules to particular merchants based upon information in their names. Name mining text matching is defined editorially at the category level through text strings and commonly used text-matching commands. Each merchant name that is identified through name mining can be processed in a number of ways, including assignment of attributes with their associated weightings, deletion of the listing, and the identification of selected merchants as specialists”. A specialist is a business that provides a narrow range of products or services and, therefore, should not be offered as a search result for products or services outside their specialty. For example, businesses in the auto repair category with the word “radiator” in their names may be assigned a cooling system repair attribute and weighting, so that these businesses will be offered as described above, but based upon the specialized nature of their name; these businesses would also be marked, so that they are not offered as a solution for general auto repair. Name mining can also be used to assign attributes based on actual company names. An example of this is searching for merchants that have “Home Depot” in their name, assigning a uniform attribute ID/attribute weight set to all of resulting Home Depot locations, and retaining any information obtained from other sources regarding individual Home Depot locations.

The final entry, group table 255 within the database builder rules repository 250, contains information that supports a method by which businesses that advertise a particular product or service are elevated in the search process for related products or services that they are likely to sell, but may not advertise. This elevation is in the form of a group attribute and associated time based weighting. For example, lumber yards that advertise “oak” are also assigned a “hardwood” group attribute with a weighting that causes these businesses to be considered ahead of lumber yards that do not advertise any type of hardwood and behind comparable businesses that specifically advertise oak. The group table 255 uses attribute IDS to obtain corresponding group IDS and group weights. Attribute to group relationships as well as group weighting rules are typically defined through a human editorial process.

FIG. 2B also shows the information flow and business search rules associated with the merchant search engine 200 and search process. These include a search criteria 201, which describe the requirements of each particular search, the associated search results 202, and a search rules generator 280, consisting of software programs that are used to create business search rules in the form of software and parameters stored in a database ‘search’ rules repository 270. Within the database search rules repository 270, a attribute lexicon 271 is a table that consists of category specific terms and phrases used to describe products and services and the attribute IDs and group IDs associated with them. Additionally, some attribute and group IDs include a “specialist” indicator, meaning that, if these attributes are part of the criteria for a search, then specialist merchants that have these attributes may be included in that search. Additionally, some attribute and group IDs include a “mandatory” indicator, meaning that when these attributes are part of a search criteria, then only merchants that have this mandatory attribute may be included in the search results.

For example, a caller seeking a “Buick dealer” should not be offered a “Ford dealer” as an alternative, even though both merchants are in the “auto dealer” category. An attribute lexicon table is created from the ad term library 252 of the database builder rules repository 250 through an editorial process, that utilizes the ad terms of individual attributes with words and phrases provided by an editor, to create terms and phrases that callers might use to describe their needs. Additionally, relationships in the group table 255 of the database builder rules repository 250 are used to link group IDs to their associated attribute IDs in the attribute lexicon 271. In this manner, a word or phrase provided by a user can directly provide search criteria in the form of attribute IDs, associated group ID, as well as any applicable mandatory or specialist conditions.

A travel speeds rules entry, 272 within the database search rules repository 270 provides speeds that are used to estimate how long it will take callers to travel to merchant locations in a particular locale. Travel speeds allow times used to define a search area to be converted to distances, establishing a basis for including geo-indexed merchants in a given search. Travel speeds are obtained for each merchant based on its locale, and then used with the distance between that merchant and a user-provided location to calculate user-to-merchant travel time. This distance-to-time conversion creates a common unit of measure, allowing calculations that consider the time value associated with merchants versus the time required to travel to those merchants. These speeds are established for all cities in the merchant database 210. Alternatively, travel speeds may be established for different geographic areas, such as zip codes or counties. In addition, travel speeds used to calculate travel times may vary with distance for certain locales. This is especially helpful in large cities, where it can take the same amount of time to walk a particular distance, as it does to wait for the availability of other forms of transportation that then travel at a higher rate of speed. Travel speeds may also be established such that they vary by time of day, such as lower speeds during rush hour.

A category types entry 273 within the database search rules repository 270 allows for business rules used as part of a search to be selected on a category-by-category basis. Category specific business rules are based upon whether the most common transactions for that line of business involve the customer traveling to (or “visiting”) the merchant, or a merchant representative traveling to the customer (“not visit”). Most retail establishments are classified as “visit”, because the customer customarily travels to the merchant location, and travel time by customers to retail locations can be consistently applied because both endpoints are known and do not change. Many service establishments are classified as “non-visit”, because representatives of the business perform services at the customer location. In these cases, consistent determination of travel time is impractical, because non-visit merchants may not normally travel from their base of operations to customer locations, but rather from the previous customer location to the next one. Taxicabs, plumbers, and carpet cleaners, are but a few examples of non-visit businesses where travel time between the merchant and user locations is not necessarily meaningful. Additional category-based business rules may be based upon geopolitical boundary search limitations, such as only including attorneys with an address in the search locale's state, because attorneys from an adjacent state may not be licensed to provide the desired service. Other category-based business rules may specify a dialog that may be helpful in narrowing a search. An example is asking whether “residential or commercial” service is required in a request for a plumber listing.

While it is possible to realize many of the benefits of the current invention by searching for merchants only in the search locale, more comprehensive results can be obtained if surrounding areas can be considered as well. To this, the database search rules repository 270 further includes a category time entry 274, which is the travel time to the most distant merchant to be included in a search of the subject category. This travel time parameter is converted to distance based upon the travel speed of a given locale to establish the geographical area associated with the merchant pool to be considered for any given merchant search. This insures that reasonable merchant alternatives are included in each search, and that the pool of merchants is not so large that the search-process consumes excessive computational resources. Inclusion of all relevant businesses within one-half hour or more of a caller's location can be justified for business categories like car dealers that involve expensive purchases and are not densely populated. Conversely, convenience-type merchants, such as dry cleaners or pizza parlors, that are one-half hour from a user location would rarely appear in search results, because there would normally be far more suitable locations that are less time consuming to travel to. Inclusion of these businesses consumes computational resources with little gain. The geographical limits of the merchant pool do not have to be precise and, therefore, may be established in a variety of ways, such as by an airline radius centered on the search locale, a square centered on the search locale with each side based on two times the category time, driving time to each merchant location obtained from a mapping program, and all merchants in a search locale plus those outside the search locale, but inside a circle centered on the search locale.

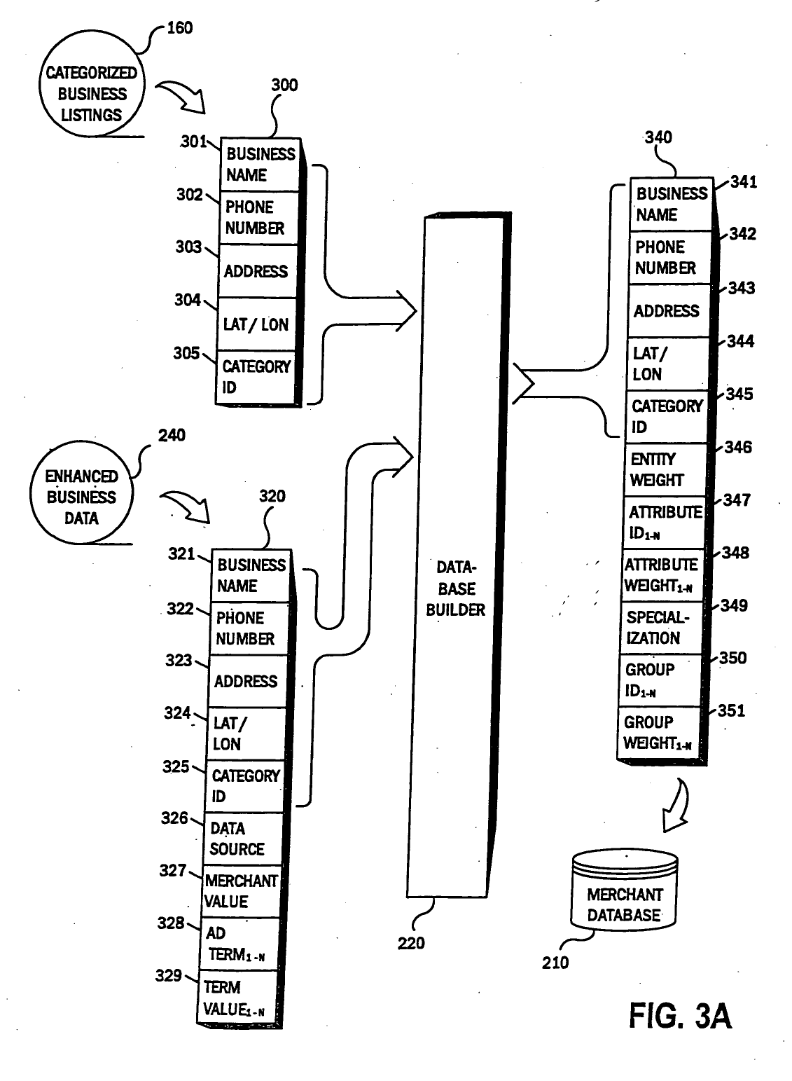

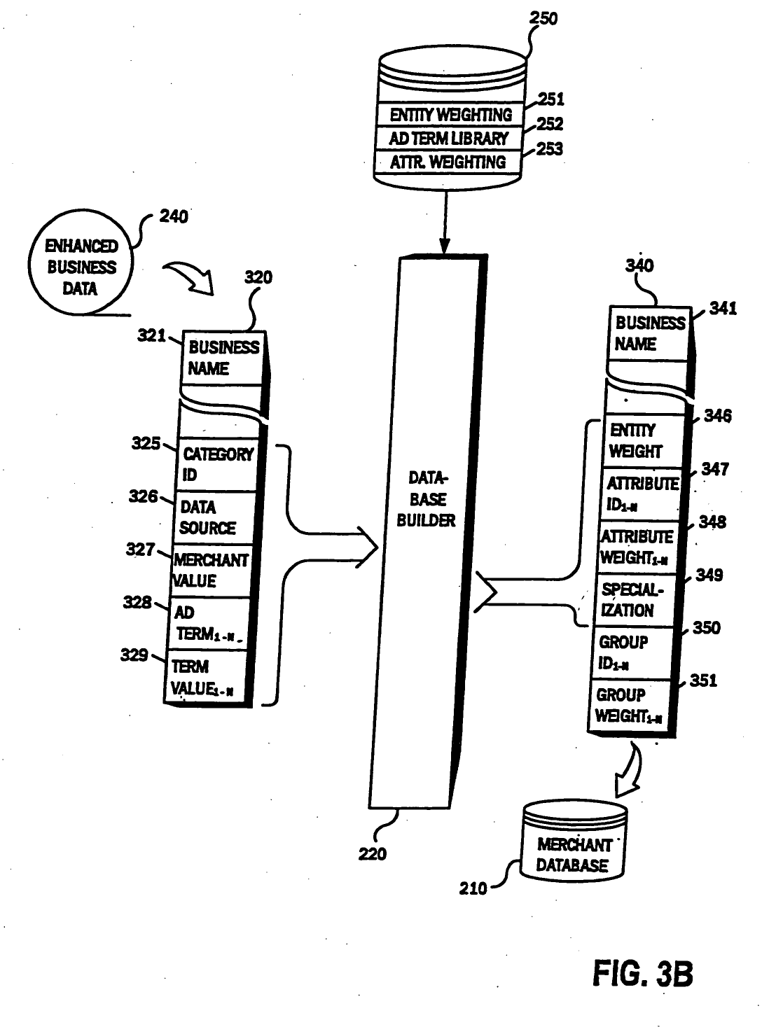

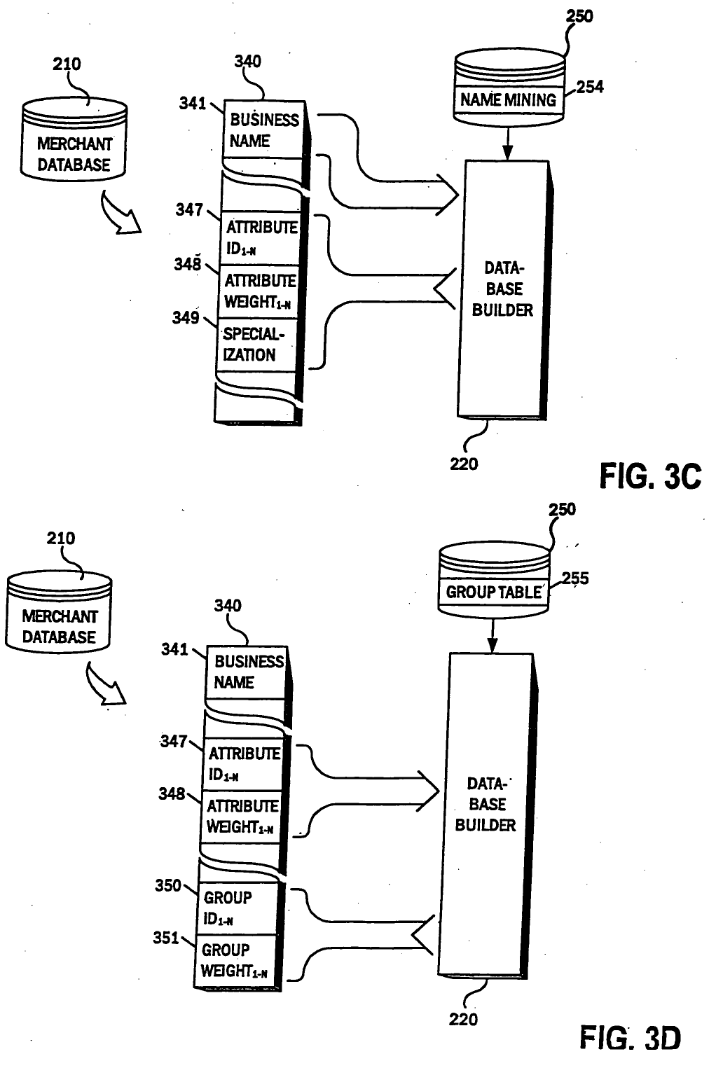

FIGS. 3A, 3B, 3C, and 3D illustrate the manner in which contents of the categorized business listings 160 and enhanced business data 240 are processed by the database builder 220, to populate the merchant database 210. This processing includes: consolidation of data from multiple sources, assignment of attribute identifiers to terminology that is descriptive of a business, and conversion of characteristics used to rank businesses to uniform time values. These functions are implemented in the database builder 220 using programmatic tools and techniques that are well known in the art, such as SQL procedures and commands.

More particularly, FIG. 3A shows the contents of the categorized business listings 160 that may be processed by the database builder 220 to produce the merchant database 210. Information entry 300 preferably includes the following for each listing: business name 301, the business's phone number 302, the address 303 of the business, latitude/longitude geographical coordinates 304 of business address 302, and a category ID 305 associated with the type of business(s) of the merchant. FIGS. 3A also shows the contents of the enhanced business data 240 that may be processed by the database builder 220 to produce the merchant database 210. In particular, information entry 320 includes some or all of the following information for each merchant: business name 321, the business's phone number 322, the business address 323 of the business, latitude/longitude geographical coordinates 324 of the business address, category ID 325 of the type of business(s) of the merchant, a data source 326 used to identify the format of data, so that the appropriate business rules can be applied to the corresponding record, a merchant value 327 that contains information such as ad size, or ratings associated with the business as an entity, one or more ad term/term value pairs, respectively represented by blocks 328 and 329, which consist of textual descriptions of products and services with associated values typically expressed in data source dependent units, such as ratings or ad fees. Since there may be multiple data sources, not all blocks will be necessarily populated for any given merchant record.

FIG. 3A further shows the database information components within a merchant database entry 340 that is produced by the database builder 220 from the combining of the contents of the information entry 300 associated with the categorized business listings 160 and the contents of the information entry 320 associated with the enhanced business data 240. Merchant database entry 340 includes the following information components: business name 341, the business's phone number 342, the business address 343 of the business, the latitude/longitude geographical coordinates 344 corresponding to address 343, and the category ID 345 of the type of business of the merchant. Additional data for some merchants may include a entity weight 346 that is a time value associated with the merchant as an entity, attribute ID/weight pairs, respectively represented by blocks 347 and 348, that identify a characteristic of the merchant and provide a time value associated with that characteristic, a specialization indicator 349 that identifies the business as a specialist, and group ID/weight pairs, respectively represented by blocks 350 and 351, that identify each group with which the merchant is associated, and its corresponding time value.

Consolidation of the business data provided by the multiple information entries 300 of the categorized business listings 160 and the information entries 320 of the enhanced business data 240 is based upon matching phone numbers and category ID, and includes elimination of duplicate data associated with the same phone number/category ID pairs. Additionally, conflicting data associated with the same phone number/category ID pairs are resolved by retaining the data from the most accurate or highly valued source. The resulting information is stored in the corresponding entries 341 through 344 of merchant database file 340. It should be noted that the stored latitude/longitude geographical coordinates 345 must correspond to the address 343, or be derived based upon address 343, as by way of commercially available geo-coding technology.

FIG. 3B illustrates the process by which entries 346-349 within merchant database entry 340 are created from entries 325-329 of the information entry 320 of the enhanced business data 240 through use of the database builder rules repository 250 by the database builder 220. In particular, ratings, ad payments, ad sizes or other data associated with the merchant as an entity represented by the merchant value 327 are converted to a time value through a lookup in the entity weighting table 251 in the repository 250, and stored as entity weight 346 within the merchant data entry 340. The assignment of attribute identifiers is based upon a lookup for each ad term text string represented by block 328 within the part of the ad term library 252 associated with category ID 325. This is based upon a best match between the ad term and the text strings in the ad term library according to the number of matching words. Other best match or exact match methods may be employed as well. The resulting attribute ID(s) are stored in location(s) represented by attribute ID block 347. The term values represented by block 329 are then converted to time value weights through lookups in the attribute weighting table 253 and stored in location(s) represented by attribute weight block 348, thereby creating one or more attribute ID/weight pairs 347/348.

FIG. 3C illustrates the use of the name mining business rules in name-mining entry 254 of the database builder rules repository 250 by the database builder 220, to process the business name entry 341 of the merchant data entry 340, as part of the creation of the merchant database 210. All business names are compared with text in the name mining 254 business rules. Businesses that match the name mining criteria may be: deleted from a particular category because they fail to match suitable criteria, specialized through storage of an indicator in the location represented by block 349, and/or assigned attributes with associated weights, with resulting data stored in the locations represented by blocks 347 and 348.

FIG. 3D illustrates the use of the information within the group table entry 255 of the database builder rules repository 250 by the database builder 220, to process the contents of the merchant data entry 340, to create the merchant database 210. In particular, FIG. 3D shows group processing in which all attributes associated with a given merchant are checked against the group table 255, to determine whether the associated record should include group identifiers and weighting. The group ID and associated weightings are extracted from the group table 255 and stored as group ID/weight pairs in the locations represented by blocks 350 and 351 of the merchant data entry 340. It may be noted that group ID/weighting pairs are not duplicated in the event that a merchant record has several attributes belonging to the same group.

Those skilled in the art will appreciate that other diverse data sources and formats may be employed to obtain consolidated merchant data consistent with the spirit of our invention. Additionally, there are a variety of available facilities that may be used to create, modify, or delete individual records in the database, using well-understood software techniques. Typical uses of these facilities are by advertisers to “self register”, advertising sales people to add new customers, and administrators to correct information associated with individual businesses.

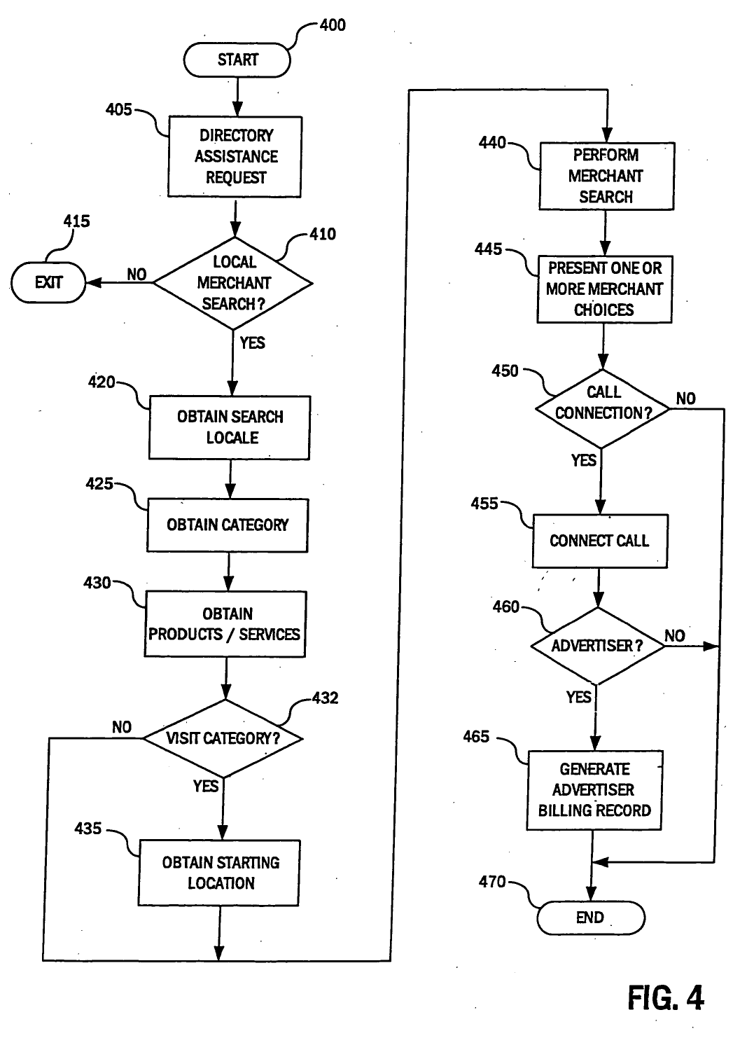

Attention is now directed to FIG. 4 which is a flow diagram of a process for providing enhanced directory assistance using the goods/services provider information storage and retrieval system of the present invention described above with reference to FIGS. 2A-3D. After beginning at start step 400, a request for directory assistance is received from a caller over a telephone connection, at step 405. The voice server or a human operator processing the call determines whether the request can best be met through a needs-based local merchant search, or ‘other’ services, in query step 410. Step 415 illustrates the ‘other’ services path, such as an alphabetical lookup, which corresponds to the answer to query step 410 being No, and is not part of the present invention. If the caller's request can best be met through a product/service local merchant search (the answer to query step 410 is YES), then a search locale, in which the caller is seeking a merchant listing, is collected in step 420. Search locales may be provided in many ways, including city names, landmarks, and neighborhoods. The type of business being sought by the caller is next determined in step 425, through techniques similar to those employed for known category search services.

The process then transitions to step 430, which provides an opportunity for a caller to provide product or service requirements to be included in the selection of a suitable business. In particular, the desired products or services described by the caller are used to search the attribute lexicon entry 271 in the database search rules repository 270 (FIG. 2B) and obtain corresponding attribute and group IDs as well as any associated specialist or mandatory indicators. A dialog between the caller and the operator, or voice server, may be necessary, to insure that the user's need are translated to a matching attribute supported by the merchant database 210.

The routine then transitions to query step 432, wherein it is determined whether the category identified in step 425 is of the visit type (the answer to step 432 is YES), which requires that the user's travel time to a merchant location be determined, so that the specific place where the user is located, or wishes to find a merchant near, must be determined. This user location information is then obtained in step 435, and may be provided by the caller in a variety of forms, including street address, intersection, landmark, or a “don't care”, which defaults to a pre-selected location within a city. This user location information may include a city that is different from the search locale obtained from the user in obtain search locale step 420. The user's location is then converted to a latitude and longitude, using techniques well known to those skilled in the art. It may be noted that, for callers who wish to use their current position as the user location, and have ANI enabled or are equipped with devices that support location based services it may be possible obtain the latitude and longitude of the user's current position through the communications network. At the conclusion of step 435 (or in the case that the answer to query step 432 is NO), the parameters available for the performance of a local merchant search are: the search locale, the category ID(s) of the desired business, attribute ID(s) of desired products and/or services, any group ID(s) associated with the desired products and/or services, any specialist or mandatory attribute indicators, and the location at or near to which the user desires the merchant to be.

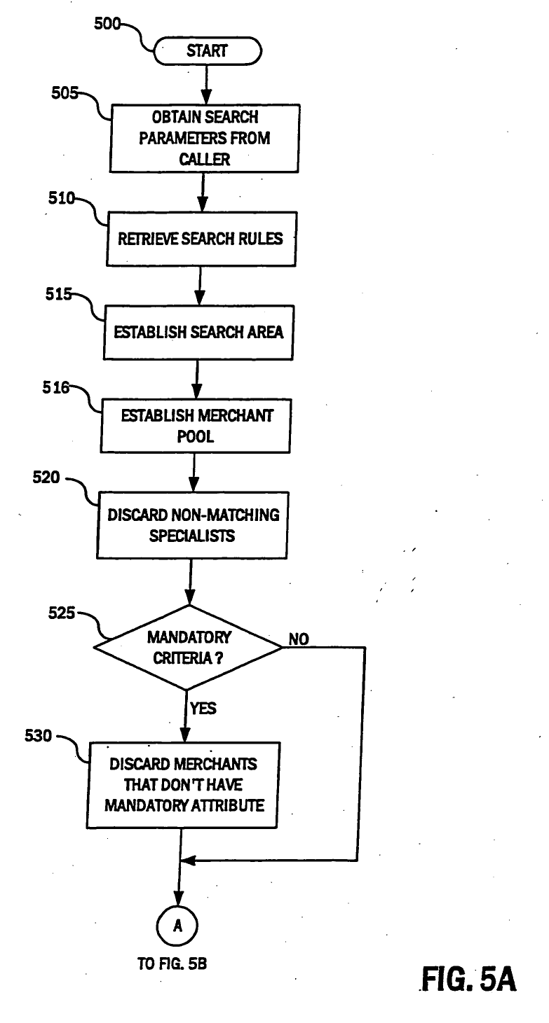

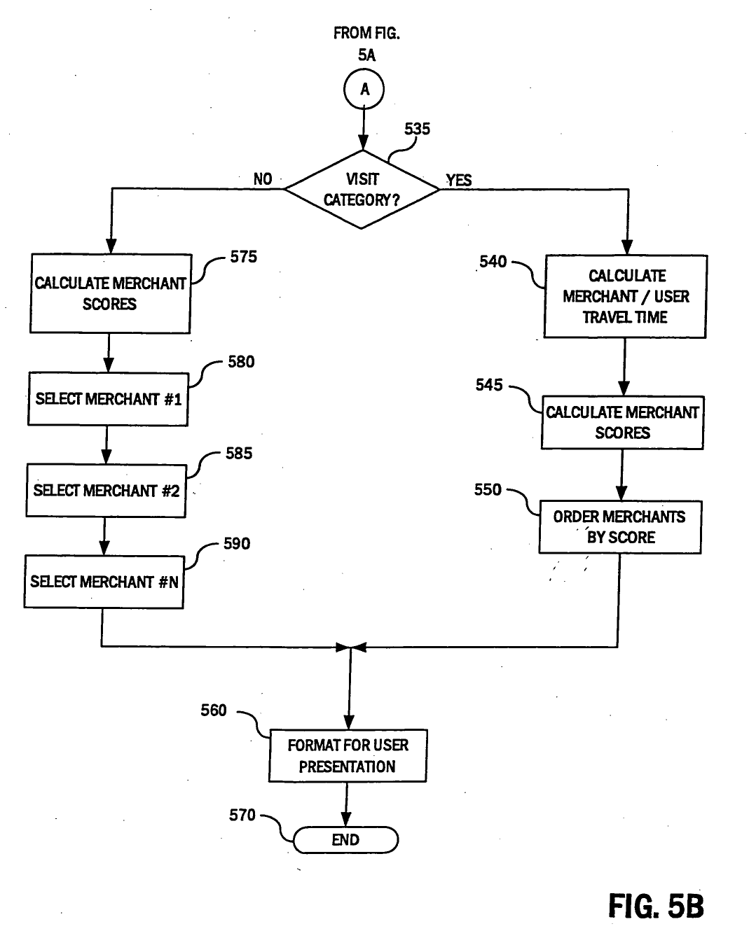

Next, in step 440, a local merchant search (to be described below with reference to the flowchart of FIGS. 5A and 5B) is performed, using search parameters available at the conclusion of step 435. One or more search results are then presented to the caller in step 445. This presentation may be effected through a voice server, and may include options for the user to navigate through a merchant list, request that he/she be directly connected to a selected merchant, or receive textual listing information through SMS messaging or other means. At this point in the process, a determination is made, in query step 450, whether or not a call connection is to be effected. If not (the answer to query step 450 is NO), the routine proceeds to step 470, wherein the call is terminated. If the call is to be connected to the merchant (the answer to query step 450 is YES), the routine proceeds to step 455. Call connection is effected in step 455 through well-understood techniques.

Next, in query step 460, the process determines whether connected calls are revenue-generating through pay-per-call advertiser fees (the answer to query step 460 is YES). All processing is completed for non-advertiser calls (the answer to query step 460 is NO), as shown at step 470. Where the answer to query step 460 is YES, the routine transitions to step 465 wherein the connection of calls to advertisers results in the creation of an associated billing record, which is forwarded to a billing system using well-understood techniques. No further processing is required at the completion step 465, as shown by step 470.

It will be appreciated by those skilled in the art that there are many possible implementations and delivery vehicles for directory assistance information services. The sequence of the steps comprising a call illustrated in FIG. 4 can be reordered in numerous ways, additional steps may be included, or some steps may be eliminated. In addition, there are alternative user interfaces that may be employed as a result of the emergence of multi-modal telephone equipment. Thus, implementations of the invention may include: the use of visual displays for presentation of menus and choices that are part of the call flow, as well as search results; the use of keypads for text entry; the use of navigation keys for the selection of choices or menu items; and speech recognition and/or human operator interaction, in combination with visual displays, keypads, and navigation keys.

An example of a multi-modal embodiment of this type is the use of voice to provide terms and phrases such as the search locale, user address, business type, and desired products or services with subsequent activities resolved through a visual display and keypad. Furthermore, directory assistance service in accordance with the invention may be delivered through a wide range of networking options such as: wireline telephone, cellular or PCS telephone, SMS, voice over IP, SMS, MMS, wi-fi, and dedicated data channels.

FIGS. 5A and 5B, taken together, depict a flowchart of the steps of a merchant search routine according to an embodiment of the present invention. After beginning at start step 500, search parameters that have been collected prior to step 440 of the flowchart of FIG. 4, described above, are supplied to the merchant search engine in step 505. Next in step 510, the search engine retrieves the travel speed associated with the search locale from the travel speeds 272 table of the database search rules repository 270 (FIG. 2B). Additionally, the category ID obtained in step 425 of the flow chart of FIG. 4 is used to retrieve the category type and category time using the category type 273, and category time 274 tables, respectively, of the database search rules repository 270 (FIG. 2B).

The merchant search routine next transitions to the establish (merchant) search area step 515, which consists of: converting the travel time of the selected category to a distance, based upon the travel speed of the search locale; dividing the value of the resulting distance by a constant, to create a decimal degrees-based distance factor; and using this distance factor to define the limits of a box centered on the latitude and longitude of the search locale with sides twice the distance factor. Other techniques may be used to create a search area, such as selected zip codes, a city name, or a combination of distance based and geographic areas.

Next, in step 516, the merchant pool is established by retrieving all merchants that match the selected category ID and have a location within the range defined by the search area established in step 515. This pool is then narrowed to discard non-matching specialists in step 520, by eliminating any ‘specialist’ merchants that do not have attributes that match attributes with ‘specialist’ indicators in the search criteria. The routine then proceeds to step 525.

If in query step 525, it is determined that the search criteria includes one or more mandatory attributes (the answer to query step 525 is YES), then the merchant pool is narrowed in step 530, by eliminating any merchants that do not have attributes that match the mandatory attributes in the search criteria. If the answer to query step 525 is NO, or upon completion of discard step 530, the routine transitions to query step 535 (FIG. 5B), query step 535 it is determined whether the search algorithm to be employed is based on a visit or non-visit category. For visit categories (the answer to query step 535 is YES), the routine proceeds to step 540 which calculates the travel time between each merchant and the user location. This time may be derived using well-understood techniques, by first using the latitude and longitude of each merchant and the latitude and longitude of the user location, to calculate an airline distance between the user location and each merchant location. The travel time for each merchant is then derived by dividing these distances by the travel speed associated with the city in which the merchant is located. Travel time may also be derived using other methods including, but not limited to, the previously mentioned distance based travel speeds, time of day based travel speeds, and route calculations similar to those used in commercially available “driving directions” products.

Next in step 545, a time score for each merchant is calculated. This time score is the sum of any entity weight and weights of attributes matching the search criteria. Weights of any matching groups are also included in this sum if the corresponding attribute is absent. The travel time for the merchant is then subtracted from this total weighting amount. The routine then transitions to step 550, wherein merchants are sorted in descending order by score.

Data associated with the merchants with the highest scores is then formatted for presentation to the user in step 560. This operation may vary among service providers, but typically includes supplying the business name, address, and phone number, and calculated travel time or distance. Additional information about the merchant, such as attribute(s) that match the search criteria, hours of operation, credit cards, or delivery capabilities can also be made available as part of step 560, as in the case where the caller has a mobile phone with a visual display. No further processing is required at the completion step 560, as shown by step 570.

If, in query step 535, it has been determined that the category of the subject search is non-visit (the answer to step 535 is NO), then a non-visit search methodology is employed. As previously discussed, the travel time between non-visit merchants and user locations is not readily obtainable, since many non-visit service providers travel from customer-to-customer, rather than from their place of business to a customer location, so that the approach described in steps 540 through 550 is not optimal for these types of businesses.

More particularly, for the non-visit category, step 575 calculates merchant scores. All merchants from the merchant pool that are located within the search city have their scores based upon matching merchant, attribute, and group weights, as described above, for step 545 (ignoring distance). All merchants in adjacent cities have their scores based upon matching weights, as described for step 545, less the travel time from the center of that adjacent city to the user location. All merchants are then organized in descending order by score.

The routine then transitions to step 580, which provides for the selection of the first merchant (merchant #1) for presentation to the caller. This may be effected by establishing a list of merchants prioritized into sets of merchants based upon scoring ranges, and then randomly selecting a merchant from these sets for presentation to the user caller. For example, the first merchant presented in step 580 can be selected from a set of merchants with scores that are within 85% of the highest score, the second merchant (merchant #2) presented in step 585 can be randomly selected from a set that includes all merchants with scores within 70% of the highest score, and a third or nth merchant selected at random in step 590 from the total pool. The routine then transitions to step 560, wherein data stored for the selected merchant is formatted for presentation to the user, as described above. This random selection methodology may alternatively be implemented by applying the concepts of time valued attributes, travel time, and random selection within sets selected through other predetermined methods that may be readily determined by those skilled in the art.

Although the goods/services provider information storage and retrieval system of the present invention has been described with respect to its application to a directory assistance (DA) application, the methodology detailed herein applies well beyond traditional operator-based DA, and includes any form of database search that utilizes a telephone or mobile device. This includes any other combination of audio, visual, textual, and graphical user interface (GUI) interfaces. One example is multi-modal applications, such as speech-in, visual-out, with keypad-based navigation. Also, it is to be understood that the invention is not limited to traditional circuit switched telephony, but applies to wired, wireless, Internet protocol, wi-fi, etc. Moreover, it can take advantage of location-based services, by reducing operator/user dialog.

In view of the many possible embodiments to which the principles of the invention may be put, it should is illustrative only, and is not to be taken as limitative of the scope of the invention. For example, while the invention has been illustrated with reference to a structured database and accessed through SQL calls and procedures, other embodiments within the scope of the invention can be created, using other technologies, including but not limited to, Internet web site data structures and search tools. Similarly, the resulting database information components can be implemented in many ways, such as fields, table entries, name/value pairs, and objects. Therefore, we claim as our invention all such embodiments as may come within the scope and spirit of the following claims and equivalents thereto.

What is claimed:

1. A method of creating a merchant database that includes travel time based weighting of individual merchant characteristics comprising the steps of:
(a) identifying at least one differentiating characteristic of at least some merchants that differentiates them from other merchants in the database;
(b) creating a database information component representative of said differentiating characteristic; and
(c) associating a travel time based weight with said database information component that provides a quantitative measure of the relative desirability of merchants that have been assigned said database information component over merchants that have not been assigned said database information component.

2. The method according to claim 1, wherein said database information component in step (b) is a database attribute, and said travel time based weight in step (c) is an attribute weight.

3. The method according to claim 1, wherein said database information component in step (b) is a group designator, and said travel time based weight in step (c) is a group weight.

4. The method according to claim 2, wherein step (a) includes identifying specialist merchants and assigning a database attribute associated with a specialty of said specialist merchants.

5. The method according to claim 1, wherein said database information components indicate an entity weighting.

6. A method of enabling a user of an information storage and retrieval service to obtain information about a merchant that provides goods and/or services of the type sought by said user, from a merchant database that contains information about multiple merchants by way of a telecommunication-based request to said service, said method comprising the steps of:
(a) determining times of travel between a location associated with said user and the locations of identified merchants that may be providers of goods and/or services of the type sought by said user, as a result of a search of said information contained in said merchant database ;
(b) organizing a list of said merchants identified in step (a), in which said identified merchants are prioritized for presentation to said user, based upon respective scores, associated with said identified merchants, and derived in accordance with said times of travel determined in step (a); and
(c) presenting to said user, by way of a telecommunication link between said information storage and retrieval service and said user, information associated with at least one of said identified merchants, selected from said list in accordance with order of priority.

7. The method according to claim 6, wherein step (b) comprises generating a score for at least one respective identified merchant based upon at least one travel time weight database information component assigned to said respective identified merchant and contained in said database.

8. The method according to claim 6, wherein step (a) comprises determining a respective time of travel between said location associated with said user and the location of said respective identified merchant, in accordance with an information component representative of speed of travel that is associated with the location of said respective identified merchant and the distance between said location associated with said user and the location of said respective identified merchant.

9. The method according to claim 6, wherein step (a) comprises determining a respective time of travel between said location associated with said user and the location of said respective identified merchant, in accordance with a plurality of travel time components associated with a plurality of travel route segments that form a travel route between said location associated with said user and the location of said respective identified merchant.

10. The method according to claim 6, wherein step (a) includes only those merchants that are located within a geographical area that is determined through use of a travel speed database information component associated with a location provided by said user and a prescribed maximum travel time database information component associated with the type of business that such user is seeking.

11. The method according to claim 7, wherein step (b) comprises generating a respective score for a respective identified merchant, based upon a plurality of different information components representative of respectively different characteristics of said respective identified merchant.

12. The method according to claim 11, wherein said respectively different characteristics are associated with aspects of goods and/or services provided by said respective identified merchant.

13. The method according to claim 7, wherein step (b) comprises generating a respective score for a respective identified merchant in accordance with at least one of the following:
i—an entity weight that is based upon characteristics of said respective identified merchant as a whole, regardless of specific products and/or services sought by said user;
ii—attribute weights relating to specific products and/or services; and
iii—group weights representative of the ability of said respective identified merchant to provide goods and/or services similar to the type sought by said user.

14. The method according to claim 7, wherein step (b) comprises generating a respective score for at least one local merchant in accordance with an information component representing a time value based upon at least one of the following:
i—the amount of media advertising associated with said local merchant.
ii—the amount of paid advertising fees associated with said merchant as an entity
iii—the amount of paid advertising fees associated with at least one attribute of said merchant

15. The method according to claim 6, wherein step (a) comprises selectively searching said information contained in said merchant database, in accordance with whether said user is to travel to the location of local merchants that may be providers of goods or services, or whether a representative of a local merchant will travel to a user specified location.

16. The method according to claim 6, wherein said telecommunication-based request elicits information regarding product and/or service criteria through category-specific questions addressed to said user.

17. The method according to claim 7, wherein step (b) comprises generating said score, in accordance with one or more groups of prescribed attributes of said providers of goods and/or services.

18. The method according to claim 7, wherein step (a) comprises selectively searching information contained in said database by eliminating specialist merchants from consideration as potential providers of said goods and/or services unless said specialist merchants have at least one database information component which indicates that said specialist merchants are providers of the type of goods or service sought by said user.

19. The method according to claim 6, wherein said merchants organized in said list in step (b) must possess specific database information components in order to be included in said list of said merchants.
